(19) United States
(12) Patent Application Publication
(10) Pub. No.: US 2010/0330290 A1
(43) Pub. Date: Dec. 30, 2010

(54) CURTAIN COATING METHOD USING EDGE GUIDE FLUID

(76) Inventors: Francis Dobler, Drusenheim (FR); Thomas Annen, Steinen (CH)

Correspondence Address: The Dow Chemical Company, P.O. BOX 1967, 2040 Dow Center, Midland, MI, 48641, US

(21) Appl. No.: 12/446,025

(22) PCT Filed: Dec. 12, 2007
(86) PCT No.: PCT/US2007/087203

§ 371 Date: Apr. 17, 2009

Related U.S. Application Data
(60) Provisional application No. 60/875,653, filed on Dec. 19, 2006.

(51) Int. Cl. B05D 1/30

(52) U.S. Cl. 427/420

(57) ABSTRACT

A method of curtain coating a substrate with at least one layer of liquid coating material comprising: moving the substrate along a path through a coating zone; providing one or more liquid coating materials in the form of a free-falling curtain which extends transversely to said path and impinges on said moving substrate; laterally guiding said free-falling curtain by edge guide elements; providing an edge guide fluid in contact with the free-falling curtain and the edge guide elements, wherein the edge guide fluid is an elastic liquid having a recoverable shear of at least 2 at a shear rate of 10,000 s⁻¹, as measured by means of a cone-plate rheometer, and comprising an aqueous solution of an organic polymer.

### CROSS-REFERENCE TO PRIOR APPLICATION

This application claims the benefit of U.S. Provisional Application No. 60/875,653 filed Dec. 19, 2006.

### BACKGROUND OF THE INVENTION

The present invention relates to a method of curtain coating a substrate with at least one layer of liquid coating material wherein the substrate is moved along a path through a coating zone and a free falling curtain of liquid coating material impinges on the substrate. More particularly, it relates to an improved curtain coating method using an edge guide fluid being in contact with the free-falling curtain and edge guide elements laterally guiding the free-falling curtain.

Curtain coating processes are being used increasingly as precision coating processes in various fields, e.g. coating paper, paperboard and polymeric substrates.

In former times curtain coating was mainly used for the manufacture of photographic papers and films and pressure-sensitive copying papers. The manufacture of photographic papers includes the simultaneous application of several photographic layers to a paper or plastic web and is for example described in U.S. Pat. No. 3,508,947 and U.S. Pat. No. 3,632,374. Recently, curtain coating technology has also been used for the manufacture of paper especially suitable for printing, packaging and labeling purposes. Examples of paper types that are presently coated by the use of the curtain coating technology include thermal, carbonless and ink jet papers.

In a curtain coating process a substrate, such as paper or paperboard, is moved along a path through a coating zone and a free-falling curtain of liquid coating material impinges on the substrate. It is known that the free-falling curtain must be guided laterally to prevent contraction of the falling curtain under the effect of surface tension and to keep a constant and defined width. In the art, the contraction of the falling curtain is also known as “curtain necking”. The necessary guidance of the falling curtain is obtained by so-called edge guide elements. In general, the edge guide elements are stationary solid members and have a contact surface with the falling curtain. U.S. Pat. No. 6,982,003 discloses an example of an edge guide. Typically, they are attached to the slide hopper which is used to supply the coating liquid to the falling curtain and extend downwardly from the initial point of free fall of the curtain. Some distance away from the edge guide elements the free falling curtain is characterized by a velocity v being at first approximation v=(2gX)^{1/2} wherein g is the gravitational acceleration and X is the distance from the initial point of free fall of the curtain. At the contact surface with the edge guide elements the relative velocity of the liquid curtain is 0. As a consequence there is a velocity gradient close to the contact surface with the edge guide elements. This velocity gradient results in weakening of the curtain along the contact surface. The curtain may become instable and a separation from the edge guide elements may be the consequence. Due to the contraction of the curtain a continued coating is then no longer possible.

It is known to provide an additional liquid to the edges of the curtain in order to reduce or avoid the velocity gradient within the curtain. See, e.g., U.S. Pat. No. 7,169,445. Wetting contact of the edges of the falling curtain with the edge guide elements should be maintained along the entire length of the edge guide to avoid a break of curtain at its edges. This additional liquid is usually designated auxiliary fluid (or liquid) or edge guide (lubrication) fluid (or liquid). Even using an edge guide fluid, the most critical issue is that below a certain volume flow of coating liquid the falling curtain is not stable anymore as it does not stick along the edge guide elements and tears away. This issue actually limits the minimum coat weight which can be applied for a given coating speed.

Various references relate to curtain coaters comprising edge guide elements and means to provide and dispense an edge guide fluid between the curtain edges and the edge guide elements. However, most of those references do not address the characteristics of the edge guide fluid and the type of fluid that may be used is only discussed briefly. In most of the prior art coating methods water or a gelatin solution is used as edge guide fluid (e.g. EP-A-0 740 197, U.S. Pat. No. 3,632,374, U.S. Pat. No. 4,830,887, U.S. Pat. No. 5,328,726 and U.S. Pat. No. 5,395,660). U.S. Pat. No. 4,479,987 additionally mentions cellulose esters and polyacrylamide for use in the auxiliary liquids.

Amongst the prior art references only EP-A-1 023 949 is focused on the properties of the edge guide fluid. It is stipulated that an edge guide fluid having a viscosity which is greater than the viscosity of the liquid coating material is advantageous and allows curtain coating with minimal volume flow of coating liquid. This reference is exclusively directed to the application of photographic silver halide emulsions typically having a viscosity of less than 50 mPa·s. It is further disclosed that the viscosity of the edge guide fluid is preferably from 50 mPa·s to 200 mPa·s. The edge guide fluid may be glycerol or a liquid comprising a water-soluble polymeric compound. It is preferred that the edge guide liquid comprises polyvinyl alcohol, polyvinyl pyrrolidone, maleic acid/methyl vinyl ether copolymer or butadiene/maleic acid copolymer. An edge guide fluid comprising polyacrylamide is disclosed in one of the examples. EP-A-1 023 949 neither mentions any molecular weights of the polymers nor their concentrations within the edge guide fluid.

The basic idea of EP-A-1 023 949 to use an edge guide fluid having a higher viscosity than the coating liquid is not practicable for the application of any coating materials having a higher viscosity compared to photographic emulsions. Typically, the pigmented coating composition applied to paper and paperboard suitable for printing, packaging and labeling purposes have a considerably higher solids content and thus a relatively high viscosity, usually in the range of from 200 to 3000 mPa·s (Brookfield viscosity at 100 rpm). The process described in EP-A-1 023 949 would not work with these coating materials due to the high viscosity of the edge guide fluid.

Accordingly, it would be desirable to have a method of curtain coating a substrate which method would ensure curtain stability at a low minimum volume flow of coating material. The desired method should be useful to apply both low or high viscous coating liquids. A low minimum volume flow allows low coat weights at lower paper and paperboard coating speeds. Low coating speeds are particularly relevant for the coating of substrates that cannot be coated by a high speed curtain coating process due to practical limitations. For example, this applies to the process of coating paperboard which is run at rather low speeds from about 200 m/min to about 600 m/min. Moreover, for higher volume flows as used for high coat weights and/or high coating speed, it would be advantageous if flow disturbances that are induced by the edge guide elements, such as standing waves at curtain edges, could be avoided.

### SUMMARY OF THE INVENTION

The invention includes a method of curtain coating a substrate with at least one layer of liquid coating material comprising:

moving the substrate along a path through a coating zone;
providing one or more liquid coating materials in the form of a free-falling curtain which extends transversely to said path and impinges on said moving substrate;
laterally guiding said free-falling curtain by edge guide elements;
providing an edge guide fluid in contact with the free-falling curtain and the edge guide elements,
wherein the edge guide fluid is an elastic liquid having a recoverable shear of at least 2 at a shear rate of 10,000 s⁻¹, as measured by means of a cone-plate rheometer, and comprises an aqueous solution of an organic polymer.

Surprisingly, the use of an elastic liquid having a recoverable shear of at least 2 at a shear rate of 10,000 s⁻¹ as edge guide fluid in a curtain coating method allows low minimum volume flow of the coating liquid.

### BRIEF DESCRIPTION OF THE DRAWINGS

FIG. 1a shows a stable free-falling curtain. (1) denotes the edge guide elements, (2) denotes the slide and (3) denotes the edge guide fluid.

FIG. 1b shows an unstable curtain due to unstable curtain edges.

FIG. 1c shows an unstable curtain due to “string” forming.

FIG. 2 is a graph of the minimum achievable coat weight versus coating speed for different edge guide fluids.

FIGS. 3a and 3b are graphs of the shear viscosity of different edge guide fluids versus the shear rate.

FIGS. 4a and 4b are graphs of the recoverable shear of different edge guide fluids versus the shear rate.

FIG. 5 is a schematic representation of a unidirectional shear flow.

### DETAILED DESCRIPTION OF THE INVENTION

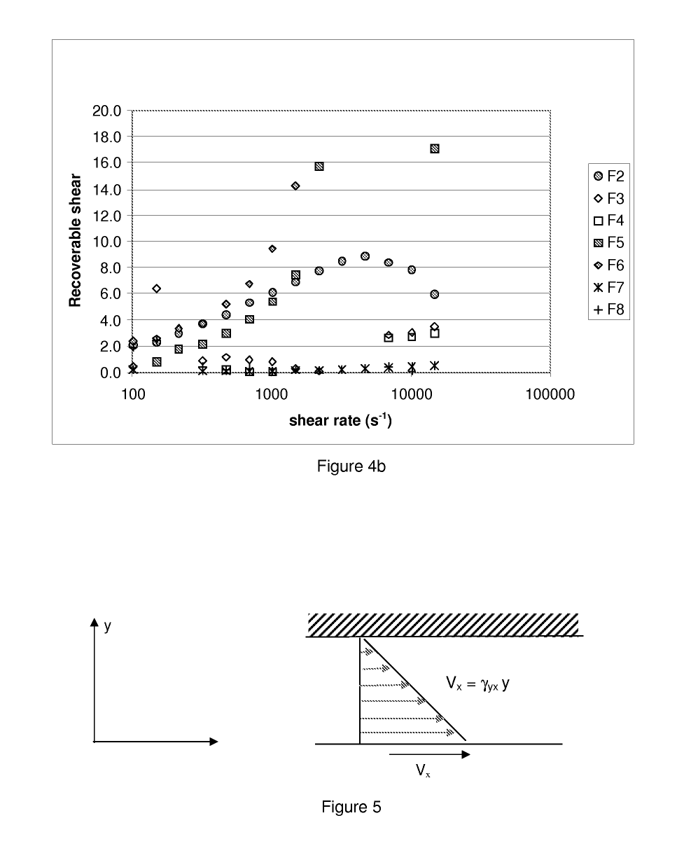

In order to appreciate the subject-matter of elastic fluids some basics of rheology will be summarized as follows. Unidirectional shear flow of a fluid is depicted in FIG. 5, wherein Vₓ denotes the velocity of the fluid in x direction and γ_{yx} denotes the shear rate or the velocity gradient in y direction. The shear flow is described by three stress vectors:
σ_{yx}=σ=η·γ_{yx}
σₓₓ−σ_{yy}=N₁ primary (or first) normal stress difference
σ_{yy}−σ_{zz}=N₂ secondary (or second) normal stress difference

In the majority of flow situations, the secondary normal stress difference is not important. For Newtonian liquids both N₁ and N₂ are zero.

It is well documented in the scientific literature (see for example “How to obtain the elongational viscosity of dilute polymer solutions?” by Anke Lindner, J. Vermant, D. Bonn in Physica A, 319, p 125 (2003)) that N₁ can be used to characterize the elasticity of a fluid via the recoverable shear which is defined as follows:

$$recoverable shear = \frac{{N}_{1}}{2 σ} \qquad ( equation 1 )$$

where for a given shear rate, [symbol] is the shear stress applied to the fluid in the rheology measurement and N₁ is the measured first normal stress difference. The recoverable shear measures the elasticity of the fluid and is defined as the ratio of the first normal stress difference to twice the shear stress. If recoverable shear >0.5 a fluid is considered to be elastic. Indeed, in the case of a highly elastic fluid the first normal stress difference can be much higher than the shear stress.

For a liquid, such as a polymer solution, the first normal stress difference measured in a shear flow field can provide information about the elasticity of the liquid. Cone-plate rheometers are well suited to measure the first normal stress difference N₁ and recoverable shear as both N₁ and σ are measured simultaneously. In such a cone-plate shear field the force F_{N} resulting from the first normal stress difference and acting in the direction of the axis of rotation (perpendicular to the plate) is:

$${F}_{N} ( γ ) = \frac{π {a}^{2}}{2} \cdot {N}_{1} ( γ ) \\ with {N}_{1} ( γ ) = first normal stress difference at shear rate γ and a = plate radius . \qquad ( equation 2 )$$

F is the net normal force actually measured in a cone-plate rheometer and is given by equation 3, F₁ corresponds to the inertial effects and is given by equation 4

$$\begin{matrix}F = {F}_{N} ( γ ) - {F}_{1} & ( equation 3 ) \\ with {F}_{1} = \frac{3 π ρ {Ω}^{2} {a}^{4}}{40} \\ ρ = specific mass of the fluid \\ Ω = angular velocity & ( equation 4 )\end{matrix}$$

From cone-plate measurement, the first normal stress difference N₁ is calculated from the measured net normal force F according to equation 5

$${N}_{1} = \frac{2}{π {a}^{2}} F + \frac{3 ρ {Ω}^{2} {a}^{2}}{20} \qquad ( equation 5 )$$

The recoverable shear is calculated according equation 1, with the shear stress being measured simultaneously with the normal force F.

Preferably, the edge guide fluid of the present invention is an elastic liquid having a recoverable shear of at least 5 at a shear rate of 10,000 s⁻¹, more preferably of at least 10 at a shear rate of 10,000 s⁻¹, even more preferably of at least 15 at a shear rate of 10,000 s⁻¹, and most preferably of at least 20 at a shear rate of 10,000 s⁻¹ (all measured by a cone-plate rheometer).

The edge guide fluid comprises an aqueous solution of an organic polymer and, in a preferred embodiment, the edge guide fluid is an aqueous solution of an organic polymer. The aqueous solution may comprise optional components, such as thickeners and surfactants.

Typically, the organic polymer has a weight average molecular weight (M_{w}) of at least 200,000, preferably at least 900,000, more preferably at least 2,000,000, even more preferably at least 3,000,000 and most preferably at least 7,000,000.

The concentration of the organic polymer in the aqueous solution is selected in order to fulfill the recoverable shear requirement defined above. Typically, it is within the range of from 0.01 to 2% by weight, preferably from 0.02 to 1% by weight, more preferably from 0.02 to 0.5, and most preferably from 0.05 to 0.2% by weight.

The type of organic polymer used in the edge guide fluid according to the present invention is not critical as long as the recoverable shear requirement of the aqueous solution as defined above is fulfilled. The organic polymer is preferably water-soluble. Within this application “water-soluble polymer” means a polymer with a solubility in water of at least 5 g in 100 g of distilled water at a temperature of 25° C. and a pressure of 1.013 bar (1 atm). In a preferred embodiment the solubility is at least 10 g/100 g of water.

Preferably, the organic polymer is a linear non-crosslinked polymer. Non-limiting examples of organic polymers to be used in the present invention include poly(alkylene oxide)s, preferably poly(ethylene oxide), anionic and cationic derivatives of poly(alkylene oxide)s, and acrylamide/acrylic acid copolymers. Specific polymers useful in the present invention include, for example, acrylamide/acrylic acid copolymers having a M_{w} of about 10,000,000 (e.g. commercially available under the tradenames STEROCOLL BL from BASF AG Ludwigshafen, Germany, and EM 115 from SNF Floerger, Andrezieux, France); a poly(ethylene oxide) having a M_{w} of about 200,000 (e.g. commercially available under the tradename POLYOX WSR 80); a poly(ethylene oxide) having a M_{w} of about 900,000 (e.g. commercially available under the tradename POLYOX WSR 1105); and, a poly(ethylene oxide) having a M_{w} of about 8,000,000 (e.g. commercially available under the tradename POLYOX WSR 303; all POLYOX WSR polymers are available from The Dow Chemical Company, Midland, U.S.A.); Sterocoll BL, EM 115 and POLYOX WSR 303 being the preferred polymers.

In a preferred embodiment of the present method the edge guide fluid has a Brookfield viscosity, measured at 100 rpm and 25° C., that is equal to or lower than 100 mPa·s, more preferably equal to or lower than 50 mPa·s. This means that the high elasticity as characteristic feature of the edge guide fluid is preferably combined with low Brookfield viscosity.

In general, the method of the present invention can be used for the application of various different liquid coating materials to the moving substrate. The type and viscosity of the liquid coating material is not critical and in fact, the present process can be run with a liquid coating material having a broad range of viscosities. Preferably, the Brookfield viscosity of the edge guide fluid is lower than that of the liquid coating material(s). The present process is particularly advantageous for the application of liquid coating materials having a Brookfield viscosity, measured at 100 rpm and 25° C., of from 200 to 3000 mPa·s, preferably from 200 to 2000 mPa·s and most preferably from 200 to 1500 mPa·s. However, the present method is also practicable with liquid coating materials having lower viscosities. Exemplary liquid coating materials to be applied by the present invention include photographic solutions or emulsions and preferably various customary coating compositions used in the manufacture of papers and paperboards for printing, packaging and labeling purposes. A method of manufacturing multilayer-coated papers and paperboards that are especially suitable for printing, packaging and labeling purposes by a curtain coating process is, for example, disclosed in WO-A 02/084029 which is incorporated herein by reference. The coating compositions described therein are especially suitable for use in the present process.

The substrate to be coated by the present method can be any substrate that is suitable for being coated by a curtain coating process. Examples include paper, paperboard, non woven and plastic web. The curtain coating of paperboard especially benefits from the present method as paperboard coating speed is generally rather low, between 150 and 600 m/min, typically between 200 and 600 m/min. In order to obtain low coat weights at low coating speeds the liquid coating material must be applied to the substrate with a minimal volume flow.

The edge guide fluid of the present invention can be used in any curtain coating method wherein the free-falling curtain is laterally guided by edge guide elements. The present method is a single layer curtain coating process or a multilayer curtain coating process. Neither the design of the curtain coater including the design of the edge guide elements nor any process parameters that are not defined by the claims are critical to the present invention. The technique of curtain coating a moving substrate is well known to a person skilled in the art and a detailed description is not considered necessary herein. Curtain coaters comprising edge guide elements and corresponding coating methods are for example described in WO-A-03/049870, WO-A-03/049871, EP-A-0 740 197, U.S. Pat. No. 3,632,374, U.S. Pat. No. 4,830,887, U.S. Pat. No. 5,328,726, U.S. Pat. No. 5,395,660, U.S. Pat. No. 6,982,003 B2, U.S. Pat. No. 7,101,592 B2, and U.S. Pat. No. 4,479,987 which are incorporated herein by reference. The manner in which the edge guide fluid is supplied to the edge guide elements and the edges of the curtain is not important for the present invention as long as a contact between the edge guide elements and the curtain is provided. Supplying methods are known from the literature and specific examples can be found in references cited above.

Typically, the flow rate of the edge guide fluid with which it is supplied to the edge guide elements and the edges of the curtain is within the range of from 1 to 100 ml/min, preferably from 5 to 70 ml/min, more preferably from 10 to 50 ml/min, and most preferably from 15 to 30 ml/min, per edge guide element.

The stability of the free-falling curtain is an issue which narrows the operation window of a curtain coater at the low coat weight and low coating speed end; i.e. for a given solids content of the liquid coating material, it sets a minimum speed below which application of a desired coat weight is no more possible, or it sets a minimum coat weight achievable with a given coating speed. The present invention allows broadening of the curtain coating operation window, as curtain stability is increased via the invention.

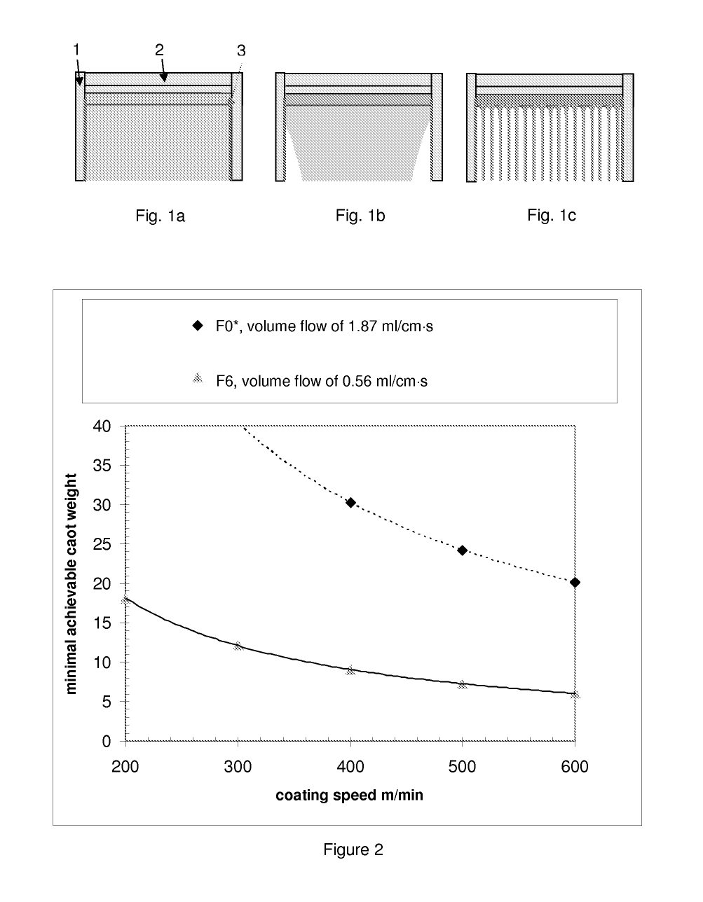

A well know limitation of curtain coating is the minimum volume flow Q_{M} of the coating liquid which is needed in order to get the curtain formed. Below that value the curtain cannot be formed and the coating liquid flows as “strings” (see FIG. 1c). In this case the actual volume flow of the coating liquid Q is lower than Q_{M} (Q_{M}>Q). Running the coating process with edge guide elements (1), there is a critical flow Q_{Ed} below which the curtain will detach from the edge guide elements (see FIG. 1b). Starting from a stable free falling curtain (supplied from slide (2)) as depicted in FIG. 1a, by reducing the volume flow, a flow value will be reached at which the curtain will tear away from the edge guide elements as depicted in FIG. 1b. This is the critical flow Q_{Ed} and, for a given coating speed and solids content of the coating liquid, it defines the minimum coat weight which can practically be applied. By continuing to reduce the volume flow of the coating liquid, the minimum flow Q_{M} is reached at which the curtain splits in strings as depicted in FIG. 1c. Q_{Ed} is actually of more practical importance because Q_{Ed}>Q_{M}; i.e. the curtain will detach from the edge guide elements before the curtain cannot be formed at all (Q_{Ed}>Q>Q_{M}). Thus, a stable curtain is formed if Q>Q_{Ed}. Q, Q_{Ed} and Q_{M} denote the total volume flows of liquid coating material in case a multilayer curtain is applied. By using an edge guide fluid (3) as described in the present invention it is possible to reduce considerably the critical volume flow Q_{Ed} at which the situation depicted in FIG. 1b happens.

Q_{Ed} sets the (total) coat weight—coating speed operation window of curtain coating at the low end values; i.e. gives the lowest (total) coat weight which can be applied at a given speed and/or imposes the lowest coating speed which has to be run for a given (total) coat weight. This is of practical importance for example for paperboard coating where Q is rather low given the low coating speed (200 m/min to 600 m/min) and targeted (total) coat weights of 12 g/m² to 25 g/m².

With the prior art edge guide fluids the coat weight—coating speed operation window of curtain coating actually does not include the coat weight—coating speed conditions relevant for paperboard. An option could be to dilute the coating liquid in order to reduce the solids content. However, dilution of the coating color is not a viable option due to its negative impacts on cost (increased drying cost) and coated paperboard properties. Using the present process employing elastic liquids as edge guide fluids it is possible to broaden the coat weight—speed operation window of curtain coating to such an extent that it finally includes almost the entire coat weight—coating speed combination relevant for paperboard coating. Of course, this is a significant economical benefit as then the targeted low coat weights can be reached without to sacrifice on the solids content of the coating liquid.

Moreover, for higher volume flows as used for high speed coating and/or higher coat weight, the method of the present invention also avoids flow disturbances that are induced by the edge guide elements, such as standing waves starting from along the curtain edges. The present method provides straight flow of the curtain along the edge guide elements.

### SPECIFIC EMBODIMENTS OF THE INVENTION

The following examples are provided as further illustration of the invention and are not to be construed as limiting. Unless stated to the contrary all parts and percentages are expressed on a weight basis.

Measurements of recoverable shear are done on a Physica MCR 301 Modular Compact Rheometer (Manufacturer: Anton Paar GmbH, Graz, Austria) in a cone plate mode (Cone CP 50-0.5/Q1, diameter 50 mm, cone angle)0.5° at a fixed temperature of 25° C. Before the normal stress measurement, the fluid is presheared for 20 s at 300 s⁻¹ shear rate. The linear shear rate is increased starting from 10 s⁻¹ to 15,000 s⁻¹ within 60 s, ad hoc rheology parameters (shear stress σ and first normal stress difference N₁) being recorded every 3 s. Given experimental limitations related to the instrument, recoverable shear measured between 100 and 10,000 s⁻¹ shear rate is considered. At high shear rate, because of the centrifugal forces, some amount of the tested lubrication liquid can be expelled from the measuring nip defined by the cone plate geometry. At lower shear rates, the net normal force F is very low and accuracy of the measurement is low because of insufficient sensitivity of the measurement device. Fᵢₙᵢₜᵢₐₗ is the average of the measured normal force F at shear rate between 0 and 100 s⁻¹. As for this shear rate the effective normal net normal force is zero Fᵢₙᵢₜᵢₐₗ is defined as the zero base line for the measurements. At high shear rate, above 100 s⁻¹, the measured normal force Fₘₑₛ is corrected according equation 6 in order to take account of the shift of the zero base line:

F=Fₘₑₛ−Fᵢₙᵢₜᵢₐₗ (equation 6)

The value of F calculated according to equation 6 is used in equation 5 in order to calculated the first normal stress difference, which is taken to calculate the recoverable shear according to equation 1.

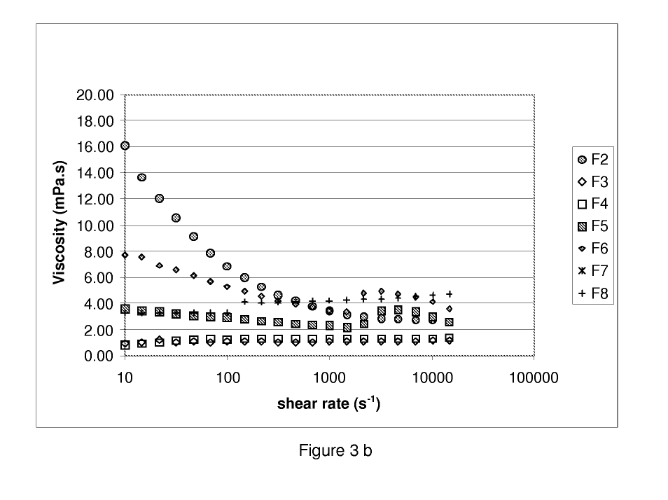

The shear viscosity is measured on the Physica MCR 301 Modular Compact Rheometer. FIGS. 3a and 3b show the shear viscosities for the formulations of Table 2.

Brookfield viscosity is another expression of shear viscosity. The Brookfield viscosity is measured using a Brookfield RVT viscometer (available from Brookfield Engineering Laboratories, Inc., Stoughton, Mass., USA). For viscosity determination, 600 ml of a sample are poured into a 1000 ml beaker and the viscosity is measured at 25° C. at a spindle speed of 100 rpm, unless a different speed is indicated.

The following tests are preformed on a slide multilayer curtain coater type forming a free-falling curtain having a height of about 300 mm Edge guides having a height of 300 mm are used in order to keep the free falling curtain width constant. The slide of the curtain coater is 280 mm wide. Various edge guide fluids are fed along the edge guides at a flow rate of 20 ml/min per edge guide element in order to improve curtain stability along the edges.

Curtain stability test have been run in order to investigate curtain edge stability as a function of the edge guide fluids. Table 1 gives the composition and characteristics of the liquid coating material.

TABLE 1
Composition and properties of the liquid coating material

| | parts by weight |
|---|---|
| Component | |
| HYDROCARB ® 90⁽¹⁾ | 90 |
| AMAZON +⁽²⁾ | 10 |
| LATEX DL 966⁽³⁾ | 12 |
| MOWIOL ® 6/98⁽⁴⁾ | 1.5 |
| TINOPAL ABP/Z⁽⁵⁾ | 0.7 |
| AEROSOL OT⁽⁶⁾ | 0.4 |
| Properties | |
| Solids content | 67% |
| Brookfied Viscosity at 10 rpm | 1550 mPa · s |
| Brookfied Viscosity at 100 rpm | 645 mPa · s |

⁽¹⁾HYDROCARB ® 90: dispersion of calcium carbonate with particle size of 90% <2 μm in water, 78% solids (available from Pluess-Stauffer, Oftringen, Switzerland);
⁽²⁾AMAZON +: dispersion of a fine Brazilian clay with particle size of 99% <2 μm in water (available from Kaolin International, The Netherlands);
⁽³⁾DL 966: carboxylated styrene-butadiene latex, 50% solids in water (available from The Dow Chemical Company, Midland, Michigan, U.S.A);
⁽⁴⁾MOWIOL ® 6/98: low molecular weight synthetic polyvinyl alcohol as a solution of 23% solids (available from Kuraray Specialties Europe, Frankfurt, Germany);
⁽⁵⁾TINOPAL ABP/Z: fluorescent whitening agent derived from diamino stilbenedisulfonic acid (available from Ciba Specialty Chemicals Inc., Basel, Switzerland);
⁽⁶⁾AEROSOL OT: aqueous solution of sodium dialkylsulphosuccinate, 75% solids (available from American Cyanamid Company, Wayne, New Jersey, USA)

Table 2 gives the composition and characteristics of the tested edge guide fluids.

TABLE 2
Composition and performance of the tested edge guide fluids

| Example | F0* | F2 | F3 | F4 | F5 | F6 | F7* | F8* |
|---|---|---|---|---|---|---|---|---|
| Type of | no | STEROCOLL | POLYOX | POLYOX | POLYOX | POLYOX | MOWIOL | MOWIOL |
| polymer | add. | BL | WSR 80 | WSR 1105 | WSR 303 | WSR 303 | 20-98 | 20-98 |
| Concentration | | 0.05 | 0.05 | 0.05 | 0.05 | 0.1 | 7 | 2 |
| (% by weight) | | | | | | | | |
| Brookfield viscosity | | 30 | 7 | 6 | 10 | 15 | 140 | 13 |
| at 20 rpm (mPa · s) | | | | | | | | |
| Brookfield viscosity | | 25 | 7 | 9 | 12 | 18 | 140 | 16 |
| at 50 rpm (mPa · s) | | | | | | | | |
| Brookfield viscosity | | 29 | 11 | 14 | 17 | 24 | 176 | 24 |
| at 100 rpm (mPa · s) | | | | | | | | |
| Q_{Ed} (ml/cm · s) | 1.87 | 0.75 | 1.68 | 1.49 | 0.56 | 0.56 | >2.99** | >2.99** |
| Recoverable shear at | | 7.8 | 3.05 | 2.67 | 27.59 | 42.36 | 0.41 | 0.10 |
| 10,000 s⁻¹ | | | | | | | | |

*comparative examples
**no stable edges even at color flow rate of 2.99 ml/cm · s
F0* uses pure water without any additives.
F2 to F8* use aqueous solutions of the following polymers:
F2: STEROCOLL BL is an acrylamide/acrylic acid copolymer having a M_{w} of about 10,000,000 (available from BASF AG Ludwigshafen, Germany);
F3: POLYOX WSR 80 is a poly(ethylene oxide) having a M_{w} of about 200,000 (available from The Dow Chemical Company, Midland, U.S.A.);
F4: POLYOX WSR 1105 is a poly(ethylene oxide) having a M_{w} of about 900,000 (available from The Dow Chemical Company, Midland, U.S.A.);
F5, F6: POLYOX WSR 303 is a poly(ethylene oxide) having a M_{w} of about 8,000,000 (available from The Dow Chemical Company, Midland, U.S.A.);
F7*, F8*: MOWIOL 20-98 is a polyvinyl alcohol (available from Kuraray Specialties Europe, Frankfurt, Germany) and commonly used as thickener.

The tests are conducted as follows: Starting from a stable curtain situation, the volume flow of the liquid coating material is reduced until the curtain tears away from the edge guide, the corresponding flow is noted Q_{Ed}. All volume flows are reported in ml of coating liquid per cm of curtain width per s (ml/cm·s).

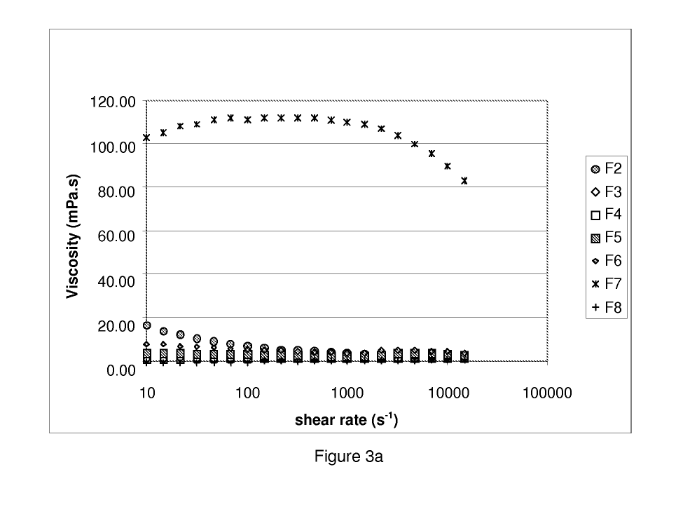

Comparative Example F0* employs pure water which is commonly used for edge guide lubrication. With pure water Q_{Ed}=1.87 ml/cm·s. FIG. 2 depicts the minimum coat weight as a function of the coating speed, the upper curve considering a flow of 1.87 ml/cm·s. For coating speeds between 200 and 600 m/min, the minimum achievable coat weights are significantly above the values relevant for paperboard coating, typically 12 g/m² for a single layer. For coating speeds under about 500 m/min the minimum achievable coat weights are still above the value of 25 g/m² relevant for a multilayer.

Comparative Examples F7* and F8* employ polyvinyl alcohol as edge guide fluid. EP-A-1 023 949 also uses polyvinyl alcohol. Trying to reproduce the teaching of EP-A-1 023 949 according to a preferred embodiment requiring that the viscosity of the edge guide fluid is 2 to 4 times the viscosity of the coating liquid this would give a viscosity for the edge guide fluid of 1300 up to 2600 mPa·s. These are very high values and liquids with such high viscosities will certainly not act as lubricant between the coating liquid and the edge guide. Thus, polyvinyl alcohol solutions having reasonable viscosities were used instead. Irrespective of the concentration, the edge stability is actually worse than for water alone; even for a coating liquid volume flow of 2.9 ml/cm·s, curtain edges remain unstable.

At the very low concentrations tested, Examples F2, F5 and F6 using very high molecular weight polymers in the edge guide fluid give the lowest values for Q_{Ed}.

In Example F6, Q_{Ed}=0.56 ml/cm·s, meaning a reduction versus pure water of more than a factor of 3. FIG. 2 depicts the minimum coat weight as a function of the coating speed, the lower curve considering the flow of 0.56 ml/cm·s. It is evident that with such an edge guide fluid a coat weight of 12 g/m² can be reached for any speed above 350 m/min and a coat weight of 25 g/m² for any speed above 200 m/min The curtain edge stability is very much improved. The coat weight—coating speed operation window of curtain coating is broadened to such an extent that it now includes the coat weight—coating speed spectrum of paperboard coating.

At the tested concentration of 0.05%, the lower molecular weight polymers used in Examples F3 and F4 give a smaller, but still remarkable improvement in edge stability.

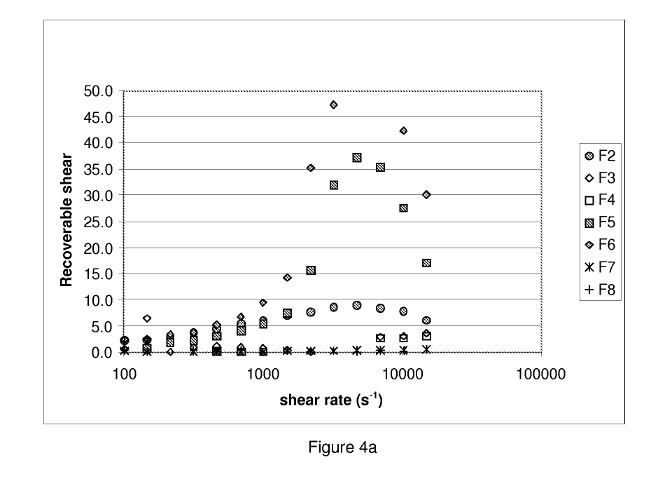

FIG. 3a and FIG. 3b depict the shear viscosities of the edge guide fluids used in Examples F2 to F8* as a function of the shear rate. FIG. 4a and FIG. 4b depict the recoverable shear of the edge guide fluids used in Examples F2 to F8* as a function of the shear rate. Comparing FIG. 4 with the values of minimum flow shown in Table 2 it is evident that low values of minimum flow correlate with high values of recoverable shear of the edge guide fluids, i.e. the elasticity of the polymer solution is responsible for the improvement of the curtain edge stability. It is further derivable from the comparison of FIG. 3 with Table 2 that the increase of shear viscosity of the edge guide fluid does not improve the edge stability.

What is claimed is:

1. A method of curtain coating a substrate with at least one layer of liquid coating material comprising:
moving the substrate along a path through a coating zone;
providing one or more liquid coating materials in the form of a free-falling curtain which extends transversely to said path and impinges on said moving substrate;
laterally guiding said free-falling curtain by edge guide elements;
providing an edge guide fluid in contact with the free-falling curtain and the edge guide elements,
wherein the edge guide fluid is an elastic liquid having a recoverable shear of at least 2 at a shear rate of 10,000 s⁻¹, as measured by means of a cone-plate rheometer, and comprises an aqueous solution of an organic polymer.

2. The method of claim 1 wherein elastic liquid has a recoverable shear of at least 5 at a shear rate of 10,000 s⁻¹, as measured by means of a cone-plate rheometer.

3. The method of any of the preceding claims wherein elastic liquid has a recoverable shear of at least 10 at a shear rate of 10,000 s⁻¹, as measured by means of a cone-plate rheometer.

4. The method of any of the preceding claims wherein the organic polymer has a weight average molecular weight of at least 200,000.

5. The method of any of the preceding claims wherein the concentration of the organic polymer in the aqueous solution is within the range of from 0.01 to 2% by weight.

6. The method of any of the preceding claims wherein the organic polymer is selected from poly(alkylene oxide)s and acrylamide/acrylic acid copolymers.

7. The method of any of the preceding claims wherein the Brookfield viscosity, measured at 100 rpm and 25° C., of the edge guide fluid is lower than that of the liquid coating material(s).

8. The method of any of the preceding claims wherein the Brookfield viscosity, measured at 100 rpm and 25° C., of the edge guide fluid is not higher than 100 mPa·s.

9. The method of any of the preceding claims wherein the Brookfield viscosity, measured at 100 rpm and 25° C., of the edge guide fluid is not higher than 50 mPa·s.
